(19) United States
(12) Patent Application Publication
(10) Pub. No.: US 2020/0089175 A1
(43) Pub. Date: Mar. 19, 2020

(54) CHARACTERISTIC JUDGMENT APPARATUS, CHARACTERISTIC JUDGMENT METHOD, AND CHARCTERISTIC JUDGMENT PROGRAM

(71) Applicant: FANUC CORPORATION, Minamitsuru-gun (JP)

(72) Inventors: Ryoutarou TSUNEKI, Yamanashi (JP); Takaki SHIMODA, Yamanashi (JP); Satoshi IKAI, Yamanashi (JP)

(21) Appl. No.: 16/555,321

(22) Filed: Aug. 29, 2019

(30) Foreign Application Priority Data
Sep. 19, 2018 (JP) 2018-175153

(51) Int. Cl. G05B 13/04; G05B 13/02

(52) U.S. Cl. CPC G05B 13/042; G05B 13/0265

(57) ABSTRACT

To provide a characteristic judgment apparatus that can easily perceive a difference in characteristics of a target machine from other machines, a characteristic judgment method, and a characteristic judgment program. A characteristic judgment apparatus includes: a learning section that individually sets a parameter in accordance with an individual difference of a machine by machine learning; an acquisition section that acquires the parameter that is set; and a comparison section that compares a parameter of a target machine with a distribution of the parameter of a plurality of other machines, and outputs characteristic information that is unique to the target machine.

This application is based on and claims the benefit of priority from Japanese Patent Application No. 2018-175153, filed on 19 Sep. 2018, the content of which is incorporated herein by reference.

### BACKGROUND OF THE INVENTION

### Field of the Invention

The present invention relates to a characteristic judgment apparatus that judges characteristic information of a machine, a characteristic judgment method, and a characteristic judgment program.

### Related Art

In industrial machines including machine tools and robots, for example, (hereinafter, simply referred to as “machine”), when controlling a servomotor, a spindle motor, or the like, it is necessary to individually set a unique control parameter or a mathematical model parameter for calculating a machine characteristic in advance. In order to reflect the individual difference of the machine characteristics to thereby set these parameters with improved precision, it is necessary to repeat experiments under a variety of conditions and acquire data therefrom, thereby determining appropriate parameters. This requires an enormous amount of time and skill.

For example, Patent Document 1 proposes an apparatus that optimizes a mathematical model that estimates a thermal displacement amount of a machine element on the basis of an operating state of a machine by repeating machine learning.

Patent Document 1: Japanese Unexamined Patent Application, Publication No. 2018-111145

### SUMMARY OF THE INVENTION

With machine learning, appropriate parameters are set to match characteristics that are different in individual machines. However, for example, since a parameter is automatically determined even for an individual machine having a characteristic that hinders operations due to initialization failure, deterioration over time, or the like, it is difficult to find that such a machine has abnormality.

It is an object of the present invention to provide a characteristic judgment apparatus that can easily perceive a difference in characteristics of a target machine from other machines, a characteristic judgment method, and a characteristic judgment program.

According to a first aspect of the present invention, a characteristic judgment apparatus according to the present invention (for example, a characteristic judgment apparatus 1 described later) includes: an acquisition section (for example, an acquisition section 12 described later) configured to acquire a parameter that is individually set in accordance with an individual difference of a machine; and a comparison section (for example, a comparison section 13) configured to compare a parameter of a target machine with a distribution of the parameter of a plurality of other machines, and output characteristic information that is unique to the target machine.

According to a second aspect of the present invention, the characteristic judgment apparatus according to the first aspect may include a learning section (for example, a learning section 11) configured to set the parameter by machine learning.

According to a third aspect of the present invention, in the characteristic judgment apparatus according to the second aspect, the learning section may receive information of a control command or feedback of the machine, and may set the parameter on a basis of a predetermined evaluation function having the information as an argument.

According to a fourth aspect of the present invention, in the characteristic judgment apparatus according to any one of the first to third aspects, the parameter may be a control parameter of the machine or a parameter a mathematical model for calculating a state of the machine.

According to a fifth aspect of the present invention, in the characteristic judgment apparatus according to any one of the first to fourth aspects, the comparison section may output, as the characteristic information, deviation from a statistic that is acquired from the distribution of the parameter.

According to a sixth aspect of the present invention, in the characteristic judgment apparatus according to the fifth aspect, the comparison section may judge, on a basis of the deviation, whether the target machine is normal or abnormal, and may output a result of the judgment as the characteristic information.

According to a seventh aspect of the present invention, in the characteristic judgment apparatus according to any one of the first to fifth aspects, the comparison section may judge, on a basis of learning in which the parameter in a known normal machine is adopted as training data, whether the target machine is normal or abnormal, and may output a result of the judgment as the characteristic information.

According to an eighth aspect of the present invention, in the characteristic judgment apparatus according to any one of the first to seventh aspects, the comparison section may output, as the characteristic information, at least any one of resonance frequency, damping, mass, inertia, and rigidity.

According to a ninth aspect of the present invention, a characteristic judgment method according to the present invention executed by a computer includes the steps of: acquiring a parameter that is individually set in accordance with an individual difference of a machine; and comparing the parameter of a target machine with a distribution of the parameter of a plurality of other machines, and outputting characteristic information that is unique to the target machine.

According to a tenth aspect of the present invention, a characteristic judgment program according to the present invention causes a computer to function as the characteristic judgment apparatus according to any one of the first to eighth aspects.

According to the present invention, it is possible to easily perceive a difference in characteristics of a target machine from other machines.

### BRIEF DESCRIPTION OF THE DRAWINGS

FIG. 1 is a block diagram illustrating a functional configuration of a characteristic judgment apparatus according to an embodiment;

FIG. 2 is a first diagram exemplifying a characteristic judgment method according to an embodiment; and

FIG. 3 is a second diagram exemplifying a characteristic judgment method according to an embodiment.

### DETAILED DESCRIPTION OF THE INVENTION

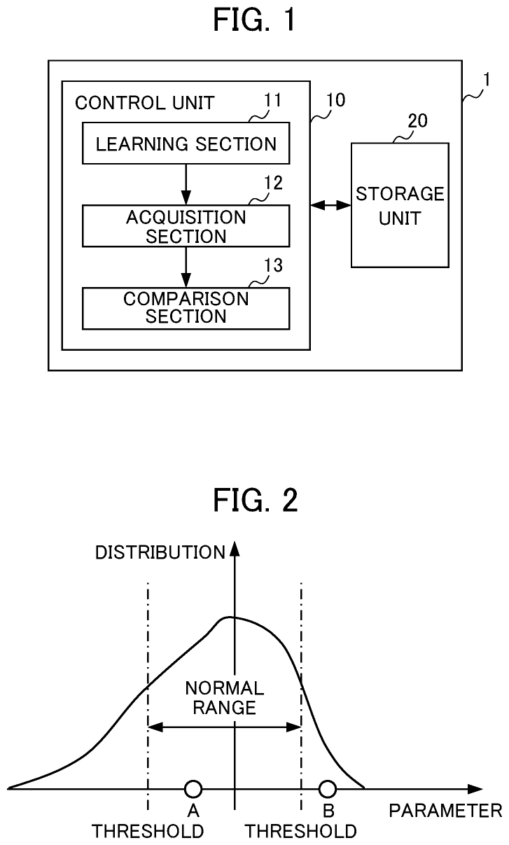

In the following, an example of an embodiment of the present invention is described. FIG. 1 is a block diagram illustrating a functional configuration of a characteristic judgment apparatus 1 according to the present embodiment. The characteristic judgment apparatus 1 is an information processing apparatus (computer) such as a server, a personal computer, or the like which includes a control unit 10 and a storage unit 20. Furthermore, for the characteristic judgment apparatus 1, various types of interfaces including input/output interfaces and communication interfaces are provided.

The control unit 10 reads and executes a characteristic judgment program stored in the storage unit 20, thereby realizing various types of functions as described later. Accordingly, the control unit 10 further includes a learning section 11, an acquisition section 12, and a comparison section 13.

The learning section 11 sets a parameter of a target machine by machine learning. More specifically, the learning section 11 receives information of control commands or feedback of a machine relating to, for example, position, velocity, acceleration, jerk, force, temperature, sound, or image, and sets a parameter by performing tuning based on a predetermined evaluation function having these pieces of information as arguments.

Examples of the evaluation function include the following. In a case of tuning a feed forward filter or a notch filter, for example, a parameter is determined that minimizes a time integral of the evaluation function upon executing a processing program for evaluation: evaluation function=[A×(position command−position)²+B×(velocity command−velocity)²+C×(acceleration command−acceleration)²+D×(jerk command−jerk)²] (A, B, C, and D are coefficients that are given in advance). It should be noted that, in a case of tuning the notch filter, a parameter may be determined so that the resonance of sound in a frequency domain is made smaller, for example. It should also be noted that, in a case of tuning the feed forward filter, a parameter may be determined so that the oscillation of an object in a photographed image becomes smaller.

In a case of tuning the gain of a controller for force control of a robot, a parameter that minimizes evaluation function=(force command−force)² is determined, for example.

A parameter that is set by machine learning is a control parameter of a machine or a mathematical model parameter for calculating a state of the machine.

First, examples of the control parameter include the following.

### Example A-1

For manufactured cutting machines, tuning of the below notch filter is performed by using reinforcement learning.

(s²+2R′ωₙs+ωₙ²)/(s²+2ζωₙs+ωₙ²)

As a result of tuning the plurality of cutting machines, a three-dimensional distribution of parameter vector ρ=(ζ, ωₙ, R) is acquired.

### Example A-2

An inverse characteristic filter in feed forward control can be expressed in accordance with the following Document A as follows.

Fₘ(s)=Pₘ(s)/P_{L}(s)=(J_{L}s²+Cₘs+Kₘ)/(Cₘs+Kₘ)=(s²+2ζω₀s+ω₀²)/(2ζωₙs+Ω₀²)

In this case, inertia J, viscosity C, and rigidity K are tuned as the control parameters.

Document A: Yasusuke IWASHITA, Tsutomu NAKAMURA, Satoshi IKAI, and Ken-ichi TAKAYAMA, “A Study on Low Frequency Vibration Suppression Control by Two-Mass System Model for Feed Axes of NC Machine Tools,” Journal of the Japan Society for Precision Engineering, 2016, Vol. 82, No. 8, pp. 745-750

Furthermore, in addition to the above, for example, various control parameters can be set by machine learning, as described below:
parameter α for adjusting position feed forward gain as;
parameter J for adjusting velocity feed forward gain Js²;
proportional gain and integration gain that are parameters for adjusting position and velocity feedback controllers;
time constant t that is a parameter for adjusting a torque command low pass filter 1/(1+τs);
proportional gain and integration gain that are parameters for adjusting gain of a current controller; and
time constant that is a parameter for adjusting acceleration and deceleration before and after interpolation.

Next, examples of the mathematical model parameters include the following.

### Example B-1

For the cutting machines, mathematical model parameters θ of a thermal displacement correction are generated by machine learning. For example, according to Patent Document 1, when defining δₙᵢ as a thermal displacement amount of the interval i at time n, and Vₙᵢ as an average velocity of the interval i at time n, the thermal displacement amount can be modeled as follows.

δₙᵢ=δ₍ₙ₋₁₎ᵢ+A×Vₙᵢ^{a}−B×δ₍ₙ₋₁₎ᵢ^{b}+C×{δ₍ₙ₋₁₎ᵢ₋₁+δ₍ₙ₋₁₎ᵢ₊₁−2×δ₍ₙ₋₁₎ᵢ}

In this case, the coefficients A, B, C, a, and b are tuned as the mathematical model parameter θ.

It should be noted that the mathematical model is not limited thereto, and a heat conduction coefficient, a nonlinear function coefficient, a neuron weight, a bias coefficient, or the like is used for the parameter θ, in accordance with a mathematical expression that is used. When the mathematical models for the plurality of cutting machines are generated, the distribution of the parameter θ is acquired.

### Example B-2

According to Document B, for example, nonlinear frictional behavior can be modeled as follows (it should be noted that detailed explanations for the mathematical expression is omitted):

Cₛ(t)=−C₁−Cₑexp((t−t_{z})/t₁)−DₛV_{fb} if t≤t_{z}

Cₛ(t)=C₂+Cₑexp((t_{z}−t)/t₁)+DₛV_{fb} if t≥t_{z}

In this case, C₁, C₂, t_{z}, and Dₛ are tuned as mathematical model parameters.

Document B: Kazuhiro TSURUTA, Teruo MURAKAMI, and Shigeru FUTAMI, “nonlinear Friction Behavior of Discontinuity at Stroke End in a Ball Guide Way,” Journal of the Japan Society for Precision Engineering, 2003, Vol. 69, No. 12, pp. 1759-1763

### Example B-3

According to Document C, for example, friction torque that causes lost motion during reverse rotation of a motor can be modeled as follows (it should be noted that a detailed explanation for the mathematical expression is omitted):

τ=K₂(θ_{M}−θ_{L})+D₂(θ′_{M}−θ′_{L}) if |θ_{M}−θ_{L}|≤Δθ₁

τ=K₁(θ_{M}−θ_{L}−Δθ₁)+K₂Δθ₁+D₁(θ′_{M}−θ′L) if (θ_{M}−θ_{L})>Δθ₁

τ=K₁(θ_{M}−θ_{L}+Δθ₁)−K₂Δθ₁+D₁(θ′_{M}−θ′_{L}) otherwise

wherein “θ′” is a time differential of e. In this case, K₂, D₂, and Δθ₁ are tuned as mathematical model parameters.

Document C: Hiroshi SUGIE, Takashi IWASAKI, Hideo NAKAGAWA, and Seido KOHDA, “Modeling and Compensation for the Exponential Type Lost Motion to Improve the Contouring Accuracy of NC Machine Tools,” Transactions of the Institute of Systems, Control, and Information Engineers, 2001, Vol. 14, No. 3, pp. 117-123

### Example B-4

A method that predicts thermal displacement by a neural network is described in Document D below, for example. It should be noted that a detailed description of the prediction method is omitted. In this case, the weight of a neuron and a bias coefficient are tuned as parameters.

Document D: Toshimichi MORIWAKI, Eiji SHAMOTO, and Masahiro KAWANO, “Estimation of Thermal Deformation of Machine Tool by Applying Neural Network (Improvement of Estimation Accuracy by Utilizing Time-Series Data of Temperature on Machine Surfaces),” Journal of the Japan Society of Mechanical Engineers C, 1995, Col. 61, No. 584, pp. 1691-1696

As described above, the functions of the learning section 11 are explained on the basis of the setting examples of the parameters for the several machines; however, the parameter of the target machine for the learning section 11 is not limited thereto. Tuning by machine learning may be implemented for a variety of kinds of parameters as targets. Any parameter that is set as above is acquired by the acquisition section 12 described later, and characteristic information is outputted therefrom by the comparison section 13.

The acquisition section 12 acquires a parameter that is set by separate learning in accordance with the individual difference of a machine. It should be noted that the parameters for each machine are not limited to parameters set by the learning section 11, and may be inputted externally.

The comparison section 13 compares a parameter that is set in a machine which is a judgment target by machine learning with a distribution of parameters that are set in a plurality of other machines, and outputs characteristic information that is unique to the target machine. For example, when a parameter is decided in a newly manufactured machine similarly to existing machines, a comparative characteristic of the newly manufactured machine with the existing machines is found by comparing a parameter of the new machine with a distribution of the parameters for the existing machines. Furthermore, when the parameter is relearned accompanying the secular change of the machine, the characteristic of the machine such as deterioration can be perceived by similarly comparing with the distribution of parameters of other machines.

The characteristic information may be, for example, deviation from a statistic such as an average value acquired from the distributions of the parameters. Furthermore, the comparison section 13 may output, as the characteristic information, a parameter itself or information that can be calculated from the parameter such as resonance frequency, damping, mass, inertia, rigidity, or the like. For example, there is the relationship of ωₙ=√(K/M) among the resonance frequency ωₙ, mass (or inertia) M, and rigidity K. Therefore, once mass M, damping C, and rigidity K that are the parameters of the inverse characteristic filter Ms²+Cs+K are determined, the resonance frequency ωₙ is calculated from a relational expression. Furthermore, for example, a thermal conduction characteristic of the machine, a transfer characteristic from heat to displacement, etc., are acquired on the basis of a thermal displacement amount model.

Moreover, the comparison section 13 may judge whether the target machine is normal or abnormal on the basis of the deviation from the statistic and output a result of the judgment as the characteristic information. For example, the comparison section 13 judges the target machine as normal if the resonance frequency of the target machine falls within ±10% (50 Hz) of the average value 500 Hz of the resonance frequency. In a case in which there is a plurality of parameters, so long as at least one of these parameters is abnormal, the target machine is judged as being abnormal. Alternatively, if a vector of the parameters deviates from a normal range that is set on the basis of the distribution of the parameters, i.e., from a multi-dimensional space, the target machine is judged as being abnormal.

Furthermore, the comparison section 13 may judge that the target machine is normal or abnormal on the basis of learning in which a parameter in a known normal machine is adopted as training data (for example, auto encoder), and output a result of the judgment as the characteristic information.

It should be noted that the comparison section 13 does not limit the judgment result to either being normal or abnormal, and may output a warning message defined in a step-wise manner by the degree of the abnormality by providing a plurality of thresholds, for example.

In this way, the characteristic information of the machine includes information indicating a state of the machine such as the degree of being normal or abnormal, or the possibility of an occurrence of failure of the machine. For example, in a case in which the resonance frequency that is a parameter of a notch filter is obtained, if the resonance frequency is lower than the average, it can be estimated that the rigidity is lower than the rigidity of a normal machine, for example. Moreover, the low rigidity may suggest an abnormality raised due to a machine not being properly installed, for example. Furthermore, a parameter of the thermal displacement amount model represents displacement of the machine in relation to heat. If this parameter deviates from the normal value, it can be assumed that, for example, the axes of the machine that should have been perpendicular to each other are not properly perpendicular to each other.

FIG. 2 is a first diagram exemplifying a characteristic judgment method according to the present embodiment. In a case in which a value of a certain parameter varies in a plurality of machines and a distribution thereof is obtained as in the drawings, it is assumed that a value that is close to the average is normal. Therefore, the characteristic judgment apparatus 1 sets a value range in which samples are included at a predetermined rate (for example, a value range of ±3σ with respect to the standard deviation a) as a normal range, and determines a threshold.

The characteristic judgment apparatus 1 judges whether the machine is normal on the basis of whether a value of the parameter that is set to a machine as a judgment target falls within the normal range. For example, parameter A in the drawing falls within the normal range, and thus, it is judged that the machine is normal. On the other hand, parameter B falls outside the normal range, and thus, it is judged that the machine is abnormal.

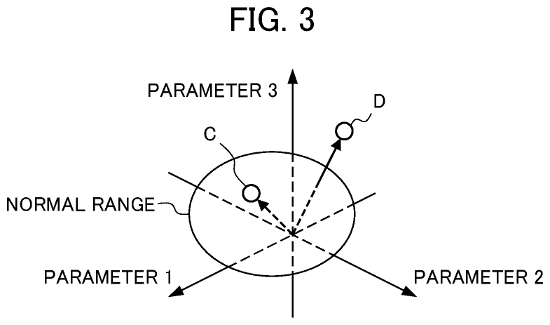

FIG. 3 is a second diagram exemplifying a characteristic judgment method according to the present embodiment. Multi-dimensional vectors defined by the combinations of a plurality of parameters (for example, parameters 1 to 3) vary within a space, and thus a certain distribution is obtained. On the basis of this distribution, the character judgment apparatus 1 determines a normal range that indicates a combination of normal parameters in accordance with a predetermined classification standard. Alternatively, the characteristic judgment apparatus 1 may determine a minimum normal range including a parameter vector by acquiring sample data of parameters only from normal machines.

The characteristic judgment apparatus 1 judges whether a machine is normal on the basis of whether a parameter vector that is set to the machine of a judgment target falls within the normal range. For example, parameter vector C in the drawings falls within the normal range, and thus, it is judged that the machine is normal. On the other hand, parameter vector D falls outside the normal range, and thus, it is judged that the machine is abnormal.

According to the present embodiment, for a parameter that is individually set in accordance with the individual difference of a machine, the characteristic judgment apparatus 1 compares a parameter of a target machine with a distribution of parameters of a plurality of other machines, and outputs characteristic information that is unique to the target machine. Therefore, the characteristic judgment apparatus 1 can easily perceive the difference in a characteristic of the target machine such as a newly manufactured machine in which a parameter is set or a machine in which a parameter is adjusted again, from the distribution of the parameters which are set in existing machines.

The characteristic judgment apparatus 1 can automate tuning of parameters or generating a mathematical model which is achieved only by skilled engineers, by setting parameters by machine learning. At this time, the characteristic judgment apparatus 1 sets a parameter on the basis of an evaluation function by using information of control commands or feedback of a machine, thereby making it possible to automatically set appropriate parameters.

The characteristic judgment apparatus 1 outputs characteristic information of a target machine on the basis of a control parameter of a machine or a mathematical model parameter for calculating a state of the machine. This makes it possible for the characteristic judgment apparatus 1 to output, as characteristic information, a physical characteristic of the machine indicated by the parameter, and further a state of a malfunction, etc. of the machine derived from this characteristic.

The characteristic judgment apparatus 1 outputs, as characteristic information, deviation from a statistic acquired from a distribution of parameters. This makes it possible to explicitly and easily indicate the degree of difference in a characteristic of the machine from those of machines of a normal group.

The characteristic judgment apparatus 1 can judge whether a machine is normal or abnormal on the basis of deviation of a parameter. The characteristic judgment apparatus 1 can thereby easily judge whether a target machine is available or not, and encourage an appropriate operation. Furthermore, the characteristic judgment apparatus 1 can judge whether a target machine is normal or abnormal on the basis of learning with a parameter of a known normal machine as training data. This makes it possible for the characteristic judgment apparatus 1 to implement a more appropriate state judgment.

The characteristic judgment apparatus 1 outputs, as characteristic information, in particular, at least any one of resonance frequency, damping, mass, inertia, and rigidity. This makes it possible for a user to easily perceive a physical characteristic of a machine and further a state of a malfunction, etc. of the machine on the basis of this characteristic.

Although the embodiment of the present invention is described above, the present invention is not limited to the abovementioned embodiment. Further, the effects described in the present embodiment are merely a list of the most preferred effects exerted from the present invention, and thus, the effects derived from the present invention are not limited to those described in the present embodiment.

In the abovementioned embodiment, the characteristic judgment apparatus 1 includes the learning section 11; however, the learning section 11 may be in an external apparatus such as a cloud server. In such a case, the acquisition section 12 of the characteristic judgment apparatus 1 communicates with the external apparatus to acquire a parameter that is a result of learning.

In the abovementioned embodiment, the characteristic judgment apparatus 1 compares a result derived from machine learning with an existing distribution to thereby judge a characteristic of a target machine; however, use and timing of the judgment are not limited thereto. For example, in a process of reinforcement learning, the characteristic judgment apparatus 1 may adopt, as an termination condition of learning, the fact that a parameter falls within a normal range. Furthermore, in a case in which a parameter derived from a result of learning falls outside the normal range, the characteristic judgment apparatus 1 may judge that learning is insufficient and may perform relearning. In such a case, if the parameter still does not fall within the normal range after repeating a learning process sufficiently, the characteristic judgment apparatus 1 may judge that the machine is abnormal.

A characteristic judgment method according to the characteristic judgment apparatus 1 is realized by software. In a case of being realized by the software, programs that constitute the software are installed in a computer. In addition, these programs may be recorded in removable media and distributed to users or may be distributed by being downloaded to a user's computer via a network.

### EXPLANATION OF REFERENCE NUMERALS

1 characteristic judgment apparatus
10 control unit
11 learning section
12 acquisition section
13 comparison section
20 storage unit

1. A characteristic judgment apparatus comprising:
an acquisition section configured to acquire a parameter that is individually set in accordance with an individual difference of a machine; and
a comparison section configured to compare a parameter of a target machine with a distribution of the parameter of a plurality of other machines, and output characteristic information that is unique to the target machine.

2. The characteristic judgment apparatus according to claim 1, further comprising a learning section configured to set the parameter by machine learning.

3. The characteristic judgment apparatus according to claim 2, wherein
the learning section receives information of a control command or feedback of the machine, and sets the parameter on a basis of a predetermined evaluation function having the information as an argument.

4. The characteristic judgment apparatus according to claim 1, wherein
the parameter is a control parameter of the machine or a parameter of a mathematical model for calculating a state of the machine.

5. The characteristic judgment apparatus according to claim 1, wherein
the comparison section outputs, as the characteristic information, deviation from a statistic that is acquired from the distribution of the parameter.

6. The characteristic judgment apparatus according to claim 5, wherein
the comparison section judges, on a basis of the deviation, whether the target machine is normal or abnormal, and outputs a result of the judgment as the characteristic information.

7. The characteristic judgment apparatus according to claim 1, wherein
the comparison section judges, on a basis of learning in which the parameter in a known normal machine is adopted as training data, whether the target machine is normal or abnormal, and outputs a result of the judgment as the characteristic information.

8. The characteristic judgment apparatus according to claim 1, wherein
the comparison section outputs, as the characteristic information, at least any one of resonance frequency, damping, mass, inertia, and rigidity.

9. A characteristic judgment method executed by a computer, the method comprising the steps of:
acquiring a parameter that is individually set in accordance with an individual difference of a machine; and
comparing the parameter of a target machine with a distribution of the parameter of a plurality of other machines, and outputting characteristic information that is unique to the target machine.

10. A non-transitory computer-readable medium encoded with a characteristic judgment program that enables a computer to function as the characteristic judgment apparatus according to claim 1.
